(19) United States
(12) Patent Application Publication
(10) Pub. No.: US 2022/0196999 A1
(43) Pub. Date: Jun. 23, 2022

(54) SOLAR OPTICAL COLLECTION SYSTEM

(71) Applicants: Stephen D. Newman, Bayshore Park (SG); David L. Newman, Adelaide (AU)

(72) Inventors: Stephen D. Newman, Bayshore Park (SG); David L. Newman, Adelaide (AU)

(21) Appl. No.: 17/560,210

(22) Filed: Dec. 22, 2021

Related U.S. Application Data
(60) Provisional application No. 63/130,187, filed on Dec. 23, 2020.

(51) Int. Cl. G02B 19/00; F24S 10/70; F24S 23/30

(52) U.S. Cl. CPC G02B 19/0009; F24S 23/31; F24S 10/70; G02B 19/0042

(57) ABSTRACT

A concentrator apparatus is disclosed. The concentrator apparatus includes a light receiver and a light concentrator. The light concentrator is arranged for the omnidirectional concentration of light toward a first focal point on the light receiver and a second focal point on the light receiver. For example, the light concentrator can include a first concentrating lens with a first focal point on the light receiver. The light concentrator can include a second concentrating lens with a second focal point on the light receive. The first and second concentrating lenses can be circumferentially spaced about the light receiver.

### CROSS-REFERENCE TO RELATED APPLICATION

The patent application is a nonprovisional patent application of, and claims priority to, U.S. Provisional Application No. 63/130,187 filed Dec. 23, 2020, and titled “SOLAR OPTICAL COLLECTION SYSTEM,” the disclosure of which is hereby incorporated herein by reference in its entirety.

### FIELD

The described embodiments relate generally to systems and techniques for collecting solar energy, and more particularly, to radiation concentration and thermal collection systems.

### BACKGROUND

Solar thermal systems can collect solar radiation in order to store energy in a transfer medium. Conventional solar thermal systems can be bulky and rely heavily on mirrors, which can lose reflective and refractive efficiency due to degradation and contaminant build-up on the mirrors. Conventional systems can be unsuited to capture solar radiation as the sun moves through a day arc without otherwise using power-intensive tracking devices. Further, the bulkiness and weight of such systems can limit the installation and adaptability of the system.

### SUMMARY

Examples of the present invention are directed to solar optical collection systems, including light concentrator apparatuses having an arrangement concentrating lenses, and assemblies and methods manufacture thereof.

In one example, a concentrator apparatus is disclosed. The concentrator apparatus includes a light receiver. The concentrator apparatus can further include a light concentrator arranged for omnidirectional concentration of light toward a first focal point on the light receiver and a second focal point on the light receiver.

In another example, the light concentrator can include a first concentrating lens to induce the first focal point. Further, the light concentrator can include a second concentrating lens to induce the second focal point. In some cases, the first and second concentrating lenses can be circumferentially spaced about the light receiver. A first side of the first concentrating lens can be closer to the first focal point than a second side of the first concentrating lens. Additionally, a first side of the second concentrating lens can be closer to the second focal point than a second side of the second concentrating lens.

In another example, the light concentrator can include a transparent material at least partially surrounding the light receiver. The light receiver can include a pipe defining a fluid pathway. The transparent material can be positioned along the fluid pathway. The transparent material can be associated with a plurality of refractive surfaces arranged about the pipe. In some cases, the transparent material can define at least one concentrating plane. The at least one concentrating plane can include a midpoint. The plurality of refractive surfaces can cooperate to induce the first focal point and the second point such that a focal axis of one or both of the first focal point or the second focal point forms a non-right angle with the midpoint of the at least one concentrating plane.

In another example, a concentrator apparatus is disclosed. The concentrator apparatus includes a light receiver. The concentrator apparatus further includes a first concentrating lens with a first focal point on the light receiver. The concentrating apparatus further includes a second concentrating lens with a second focal point on the light receiver. The first and second concentrating lenses are circumferentially spaced about the light receiver.

In another example, the concentrator apparatus includes a transparent material housing the first concentrating lens and the second concentrating lens about the light receiver. The transparent material can define a partial vacuum space between the light receiver and the first and second concentrating lenses.

In another example, the concentrator apparatus can include a third concentrating lens with a third focal point on the light receiver. The third concentrating lens can be circumferentially spaced about the light receiver with the first and second concentrating lenses. In some cases, the first, second, and third light concentrating lens cooperate for omnidirectional concentration of light toward the light receiver.

In another example, the first and second focal points are on different locations of the light receiver. Further, one or both of the first or second concentrating lenses can include a cylindrical rod lens. For example, the light receiver can include a pipe having a longitudinal axis and the cylindrical rod lens extends along the longitudinal axis. In some case, the cylindrical rod lens comprises plurality of refractive surfaces adapted to collectively induce one or both of the first or the second focal points.

In another example, a concentrator apparatus is disclosed. The concentrator apparatus includes a pipe defining a fluid pathway. The concentrator apparatus further includes an energy collection system associated with the pipe and configured to concentrate thermal energy received from a plurality of azimuths and altitudes on the pipe and heat fluid of the fluid pathway.

In another example, the energy collection system can include a transparent material. The transparent material can include a light receiving surface of the transparent material. The transparent material can further include a light exiting surface of the transparent material opposite the light receiving surface. The transparent material can further include a plurality of refractive surfaces incorporated into at least one of the light receiving surface and the light exiting surface. The transparent material can further include a first side joining the light receiving surface and the light exiting surface. The transparent material can further include a second side opposite to and aligned with the first side, the second side joining the light receiving surface and the light exiting surface.

In another example, the plurality of refractive surfaces can direct light passing through the transparent material to a collective focal point. The first side of the transparent material can be closer to the collective focal point than the second side of the transparent material. The transparent material can be at least semi-transparent. In some cases, at least a subset of the plurality of refractive surfaces can include progressively differing refractive angles from the first side of the transparent material to the second side of the transparent material.

In another example, the energy collection system can include a first portion arranged about the pipe. The energy collection system can further include a second portion moveable relative to the first portion. The energy collection system can further include an arrangement of concentration lenses between the first and second portions adapted to concentrate the thermal energy received from the plurality of azimuths and altitudes on the pipe.

In another example, the energy collection system can further include a catch mechanism disposed about the first portion opposite the pipe. The catch mechanism can be adapted to receive a mechanical input for moving the first portion relative to the second portion. In some case, the catch mechanism can include a plurality of aerodynamic blades. The first and second portions can be substantially concentric with a longitudinal axis of the pipe.

In another example, a system is disclosed. The system includes a wind turbine. The system further includes a concentrator apparatus, such as any of the concentrator apparatuses described herein. The concentrator apparatus is installed with the wind turbine.

In another example, a system is disclosed. The system includes a refrigeration truck. The system further includes a concentrator apparatus, such as any of the concentrator apparatuses described herein. The concentrator apparatus is installed with the refrigeration truck.

In another example, a system is disclosed. The system further includes a concentrator apparatus, such as any of the concentrator apparatuses described herein. The concentrator apparatus is installed with the shipping container.

In another example, a method for supplying energy to a transfer medium is disclosed. The method includes conducting a fluid through a light receiver. The method further includes transferring thermal energy to the fluid by: (i) concentrating light from a first direction to a first focal point on a light receiver; and (ii) as the light transitions from the first direction to a second direction, concentrating the light from the second direction to a second focal point on the light receiver.

In another example, the fluid can include a heat transfer medium. For example, the fluid can include one or more of water, a glycol/water mixture, hydrocarbon oils, refrigerants/phase change fluids, silicones, molten salts, a molecular solar thermal energy storage, or a zeolite-based thermal storage.

In another example, the operation of conducting can include establishing a pressure gradient of the fluid through the light receiver using a pump.

In another example, the first focal point can be induced by a first concentrating lens. The second focal point can be induced by a second concentrating lens. The first and second concentrating lenses can be circumferentially spaced about the light receiver.

In another example, the method can include collecting wind energy from an environment associated with the light receiver. The collecting can include inducing movement of a first portion of an energy collection system using the wind energy. In some cases, the first portion can include a transparent material arranged about the light receiver. The light can traverse the transparent material at the first direction and the second direction, thereby allowing the concentration of the light from the first direction to the first focal point and the concentration of the light from the second direction to the second focal point.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates a top view of a prior art Fresnel lens.

FIG. 2 illustrates a side view of an example of a concentrating lens in accordance with the present disclosure.

FIG. 3 illustrates a side view of an example of a concentrating apparatus in accordance with the present disclosure.

FIG. 4 illustrates a side view of an example of a concentrating apparatus in accordance with the present disclosure.

FIG. 5 illustrates a side view of an example of a concentrating apparatus in accordance with the present disclosure.

FIG. 6 illustrates a side view of an example of a concentrating lens in accordance with the present disclosure.

FIG. 7 illustrates a side view of an example of a concentrating lens apparatus in accordance with the present disclosure.

FIG. 8 illustrates an example scanning electron microscopic image of a surface having meta-optics formed thereon.

FIG. 9 illustrates an isometric view of an example system including a concentrator apparatus of a solar optical collection system.

FIG. 10 illustrates a cross-sectional view of the concentrator apparatus of FIG. 9, taken along line 10-10 of FIG. 9.

FIG. 11A illustrates a detail view 11A-11A of a lens of the concentrator apparatus of FIG. 10.

FIG. 11B illustrates an isometric view of a section of a concentrating lens and an associated focal point of the lens.

FIG. 12 illustrates a cross-sectional view of an example concentrator apparatus of a solar optical collection system including a heat transfer medium.

FIG. 13 illustrates an example energy collection system.

FIG. 14 illustrates an example system including a concentrator apparatus and a wind turbine.

FIG. 15 illustrates an example system including a concentrator apparatus and a truck.

FIG. 16 illustrates an example system including a concentrator apparatus and a shipping container.

FIG. 17 illustrates a flow diagram for supplying energy to a transfer medium.

### DETAILED DESCRIPTION

The description that follows includes sample systems, methods, and apparatuses that embody various elements of the present disclosure. However, it should be understood that the described disclosure can be practiced in a variety of forms in addition to those described herein.

The following disclosure describes systems and techniques to facilitate the collection and concentration of solar radiation into a transfer medium. A solar optical collection system including a concentrator apparatus can be provided to collect solar radiation and transfer thermal energy to a heat transfer medium. Sample heat transfer mediums can include water, a glycol/water mixture, hydrocarbon oils, refrigerants/phase change fluids, silicones, molten salts, a molecular solar thermal energy storage, or a zeolite-based thermal storage. The concentrator apparatus can include an arrangement of concentrating optical lenses that are arranged about the heat transfer medium. The concentrating lenses can be adapted to collect the solar radiation and direct and focus the radiation toward the heat transfer medium. The heat transfer medium receives the focused radiation and stores the radiation as heat energy. Conventional solar thermal systems are often limited by the position of the sun or otherwise include bulky, power-intensive tracking systems that are used to physically manipulate and move the entire conventional system.

The concentrator apparatuses of the present disclosure can mitigate such hindrances by providing a system that can collect solar radiation substantially agnostic to a position of the sun. For example, concentrator apparatus can be adapted to collect solar radiation as the sun progresses along a day arc or other path through the sky. The solar radiation can be collected without moving the lenses or other structures that collect the solar radiation.

To facilitate the foregoing, the concentrator apparatus can include an arrangement of concentrating lenses that are positioned about the heat transfer medium. In some cases, the arrangement of concentrating lenses can be positioned circumferentially spaced about the heat transfer medium. The arrangement can allow a first subset of concentrating lenses to collect solar radiation when the sun is in a first position. The arrangement can further allow a second subset of concentrating lenses to collect solar radiation as the sun progresses along the day arc and into a second position. The arrangement of lenses can thus be configured for the omnidirectional concentration of light toward the heat transfer medium. The concentrating apparatus can therefore effectively track the sun without moving the components of the apparatus that collect and concentrate the solar radiation. The bulk and power-consumption of the concentrating apparatus can therefore be reduced.

In one example implementation, the heat the transfer medium can be held within a pipe, tube, or other conduit. The pipe can define a fluid pathway for the heat transfer medium, such as extending between a medium inlet where substantially cool transfer medium is received and a medium outlet where substantially warmer transfer medium is emitted. The fluid pathway of the concentrator apparatus can be a segment of a fluid circulation system in which the heat transfer medium is continually circulated for heating by the apparatus, and for heat extraction by other thermal components of a system, such as a heat exchanger. An energy collection system can be associated with the pipe in order to concentrate the thermal energy on the pipe and heat the fluid in a fluid pathway. The energy collection system can position and hold the arrangement of lenses about the fluid pathway in order to concentrate thermal energy received from a plurality of azimuths and altitudes of the day arc of the sun. For example, the energy collection system can include a first portion and a second portion that holds the arrangement of lenses substantially concentrically about the fluid pathway. The lenses can be held in an annular space between the first and second portions.

In some cases, one or both of the first and second portions can be adapted to move relative to the fluid pathway. For example, the second portion can be an outer portion that is allowed to rotate freely relative to the inner, first portion. Blades, fins, and/or other aerodynamic components can be attached to the outer surface of the second portion. The blades can collectively define a catch mechanism that can facilitate the movement of the outer, second portion upon the receipt of wind. The movement of the outer, second portion caused by the wind can be used to capture and store energy in conjunction with the solar energy.

The substantially lightweight design of the concentrator apparatus can be facilitated in part by the use of optical lenses to collect and concentrate the solar radiation. Optical lenses can weigh less than bulky mirrors used in conventional solar thermal systems. Optical lenses can also deliver more concentration of solar radiation to a heat transfer medium for a given footprint than mirrors. This can allow the overall size of the concentrator apparatus to be reduced. In turn, the concentrator apparatuses of the present disclosure can be adapted for installation in a wider variety of locations, including installing the concentrator apparatuses on the roof of a building or other preexisting structure, which can facilitate implementation with existing infrastructure. The concentrator apparatuses can also be adapted for installation with a variety of other applications, including installation with a wind turbine, a truck, and/or a shipping container.

One example lens for use with the concentrator apparatus includes a Maddox rod/lens. The lens can implement a refractive optics design in order to capture and focus solar energy onto the thermal transfer medium. As described in greater detail below, Fresnel lens and variations thereof can also be used. The lenses can be focused as a bi-aspheric convex/planar cylinder in order to create an extending depth-of-focus (EDOF) effect in the receiving media. In some cases, the lenses can be adapted to have a focal length of between 15 mm and 25 mm. Further, the focal length can be calibrated for various sunlight incident angles and wavelengths through the visible and IR range of substantially between 400 nm to 1,600 nm using the sunlight spectrum after atmospheric absorption. The lenses can be tuned to have a desired focal length for a given sunlight wavelengths, for example, such as being tuned to have an effective focal length of 15.0 mm for a 543 nm wavelength. This can allow the concentrator apparatus to be calibrated to a certain wavelength values and adaptive for capturing solar energy across a wide spectrum of wavelengths and incident angles.

It will be appreciated that a variety of different lenses can be used with the concentrator apparatuses described herein. As one example, Fresnel lenses can be used in solar collectors to concentrate light through refraction. Conventional Fresnel lenses approximate a curved lens, but with less material. Thus, a Fresnel lens weighs less than a corresponding curved lens. In some cases, the Fresnel lens focuses parallel rays of light to a focal point. Generally, a Fresnel lens includes a flat side and a canted side. The canted side includes canted facets that form refractive surfaces, which approximate the curvature of a lens. Typically, the more facets, the better the approximation of the curved lens.

Generally, all the light that passes through the Fresnel lens is concentrated to a single point. Thus, the larger the surface area of the Fresnel lens, the more light is concentrated to the single point. A Fresnel lens with a greater surface area will often have a longer focal length because the light rays passing through the sides of the Fresnel lens will be focused to the same focal point that light rays passing through the central portion of the Fresnel lens pass, but the light rays passing through the sides have to travel a longer distance than the light rays passing through the center. Thus, as a general rule, the larger the surface area of the Fresnel lenses, the longer the focal length to the focal point. This is due, in part, to the symmetry of the Fresnel lens. Based on this general rule, as the surface area increases, the Fresnel lens is placed at a farther distance from the focal point, taking up more space.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length. For purposes of this specification, a concentrating plane generally refers to a plane at which rays parallel to the axis are deviated to converge to a focal point. For purposes of this specification, a focal axis is an axis the passes through a mid-point of a concentrating plane and a collective focal point.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

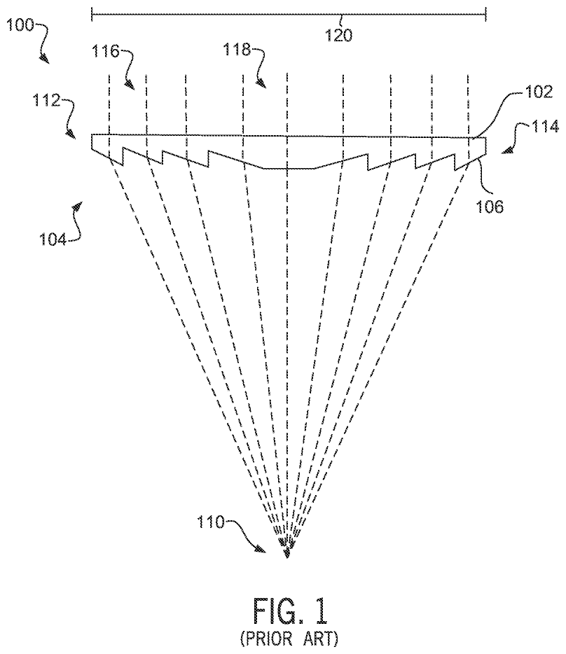

FIG. 1 depicts a prior art example of a Fresnel lens 100. Here, the Fresnel lens 100 includes a light receiving surface 102 that is generally flat. A light exit side 104 of the Fresnel lens 100 is opposite to, and aligned with, the light receiving surface 102. The light exit surface 104 includes a plurality of canted faces 106 that form refractive surfaces. Light that is generally perpendicular to the flat light receiving surface 102 enters the light receiving surface without a substantial refraction, if any. The refractive surfaces on the light exiting surface 104 refract the light towards a focal point 110. The Fresnel lens 100 is generally symmetric with a first side 112 and a second side 114 of the lens, substantially equidistant to the focal point 110. The refracted light transmitted through the side regions 116 of the Fresnel lens have a farther distance to travel to the focal point 110 than the unrefracted light at a central region 118 of the Fresnel lens 110.

The surface area of the Fresnel lens 100 is determined by the length and width of the Fresnel lens 100. In this depiction of the prior art Fresnel lens, just the width 120 of the Fresnel lens 100 is depicted.

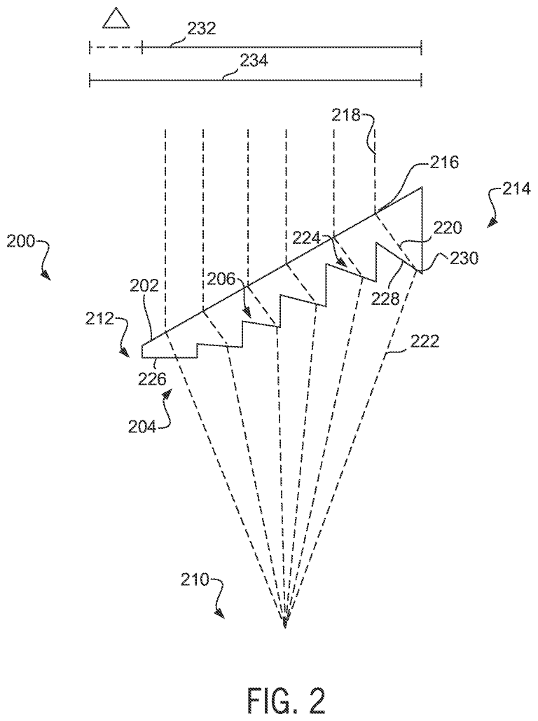

FIG. 2 depicts an embodiment of a light concentrating lens 200. In some examples, the light concentrating lens is a Fresnel lens, but the principles depicted in FIG. 2 can be applied to other types of light concentrating lens.

The light concentrating lens 200 includes a light receiving surface 202 and a light exiting surface 204. The light receiving surface 202 is generally flat, and the light exiting surface 204 includes a plurality of canted faces 206, which form refractive surfaces that affect the direction of the light rays exiting the lens 200. Each of the refractive surfaces are focused on directing the light to a single focal point 210.

A first side 212 of the light concentrating lens 200 connects the light receiving surface 202 with the light exiting surface 204. A second side 214 of the light concentrating lens 200 is opposite to the first side 212 and connects the light receiving surface 202 with the light exiting surface 204. In this example, the first side 212 is closer to the focal point 210 than the second side 214. In this example, the light concentrating lens 200 has a substantially flat light receiving surface 202; thus, the concentrating lens 200 is tilted at an angle. Further, the first side 212 is located at a greater vertical distance or elevation away from the focal point than the second side 214 of the light concentrating lens 200.

The light concentrating lens 200 can be tilted to any appropriate angle relative to horizontal. For example, the light concentrating lens 200 can be tilted to an angle of at least 5 degrees, of at least 10 degrees, of at least 15 degrees, of at least 20 degrees, of at least 25 degrees, of at least 30 degrees, of at least 35 degrees, of at least 40 degrees, of at least 45 degrees, of at least 50 degrees, of at least 55 degrees, of at least 60 degrees, of at least 65 degrees, of at least 70 degrees, of at least 75 degrees, of at least 80 degrees, of at least 85 degrees, or at least another appropriate angle, or combinations thereof.

The light concentrating lens 200 can be formed of a material that is at least partially transparent. In some examples, the material of the light concentrating lens 200 can have the characteristic of having at least 20 percent total transmittance, at least 30 percent total transmittance, at least 40 percent total transmittance, at least 50 percent total transmittance, at least 60 percent total transmittance, at least 70 percent total transmittance, at least 80 percent total transmittance, at least 85 percent total transmittance, at least 90 percent total transmittance, at least 95 percent total transmittance, another appropriate total transmittance, or combinations thereof. In some examples, the light concentrating material can be a glass, a plastic, a resin, diamond, sapphire, ceramics, another type of material, or combinations thereof.

As the light enters the receiving surface 202, the light can be refracted when the entering or received light is not perpendicular to the light receiving surface 204. In this case, the substantially parallel light rays that are generally traveling towards, but not focused on the focal point, can be refracted due to the relative angle between the incoming light and the light receiving surface 202. This refraction that occurs at the light receiving surface 202 can be a first refractive angle 216 of a light ray that bends a natural light ray 218 into a partially refracted light ray 220. The relative angle of the canted face 206 with the partially refracted light ray 220 can cause the partially refracted light ray 220 to bend into a focused light ray 222 on the focal point. Thus, the light can be refracted at multiple points while still traveling in the general direction towards the focal point.

For those light rays entering the flat light receiving surface 202 that are generally parallel, the light is refracted at the same angle to form the partially refracted light rays. The partially refractive light rays travel through and are contained within the transparent material. The partially refractive light rays are refracted into focused light rays directed to the focal point as these partially refractive light rays exit the transparent material. The transition from the partially refractive light rays to the focused light rays forms a second refractive angle 224. The second refractive angle 224 can be formed based on the angle of the canted face on the light exiting surface of the transparent material. From the first side of the light transparent material to the second side of the light transparent material, the canted faces can progressively increase in angle to focus each of the light rays along the concentrating lens' length to the focal point. Thus, the refractive angles can be different based upon the location of the light ray with respect to the concentrating lens' cross sectional length. For some canted faces 206 the second refractive angle 224 can be generally perpendicular to the partially refracted light ray 220 resulting in only a minor refraction to form the focused light ray 222. However, in other portions of the light exiting surface 204, the relative angle between the canted faces 206 and the partially refractive light ray 220 can be an acute angle or an obtuse angle to force a greater refractive correction to form the focused light ray 222. Additionally, the relative angle of the canted faces 206 can be tuned relative to an overall desired angular position of the light receiving surface 202 relative to horizontal to direct received light to a desired focal point 210.

In the depicted example, the first canted face 226 proximate the first side 212 of the concentrating lens 200 provides a minor refractive adjustment to form the focused light ray 222. Each of the canted faces 206 from the first side 212 in the direction to the second side 214 progressively form a more pronounced angle that causes a greater angle change between the partially refracted light ray 220 and the focused light ray 222. For example, the farthest most canted face 228 proximate the second side 214 of the concentrating lens 200 can form a steep acute angle 230 with the partially refracted light ray 220 resulting in a greater second refractive angle 224. In some examples, the canted face proximate the first side of the concentrating lens has a different refractive surface angle than the canted face of the second side of the concentrating lens, but each of these canted faces directs the focused light rays to the same focal point 210.

The first refractive angle 216 can be any appropriate angle. For example, a non-exhaustive list of angles that can be compatible for the first refractive angle can include angles less than 90 degrees, less than 60 degrees, less than 50 degrees, less than 45 degrees, less than 40 degrees, less than 35 degrees, less than 30 degrees, less than 25 degrees, less than 20 degrees, less than 15 degrees, less than 10 degrees, less than 5 degrees, or less than another appropriate angle.

The second refractive angle 224 of any of the individual canted faces can be any appropriate angle. For example, a non-exhaustive list of angles that can be compatible for the canted faces' refractive angles can include angles less than 90 degrees, less than 60 degrees, less than 50 degrees, less than 45 degrees, less than 40 degrees, less than 35 degrees, less than 30 degrees, less than 25 degrees, less than 20 degrees, less than 15 degrees, less than 10 degrees, less than 5 degrees, or less than another appropriate angle.

The second refractive angle 224 can be affected by the first refractive angle 216 and the relative lateral distance each of the canted faces 206 is expected to be with respect to the focal point. For example, many of the canted faces can form a negative angle between the partially refracted light ray 220 and the focused light ray 222. On the other hand, other canted faces can be oriented to form a positive angle between the partially refracted light ray 220 and the focused light ray 222.

In the depicted example, the first side 212 of the concentrating lens 200 is closer to the focal point 210 than the second side 214 of the concentrating lens 200. As a result, the concentrating lens 200 is offset or asymmetrically oriented about the focal point. Thus, each of the canted faces 206 are angled to asymmetrically focus each of the light rays to an off-centered focal point 210.

One advantage to having the concentrating lens 200 orientated at an angle relative to the focal point is that more concentrating lenses with the same surface area can be fit into the same footprint. For example, the angled concentrating lenses can increase the overall surface area that can be used to concentrate light because additional concentrating lenses can be included within the same footprint. With an increased surface area, more light can be concentrated in a smaller area, thereby enhancing the thermal efficiency of the lens.

In FIG. 2, line 232 represents the width of the concentrating lens 200 compared to the width of the Fresnel lenses depicted in FIG. 1 represented by line 234. As can be seen, line 234 is shorter than line 232, resulting in a net width difference delta (Δ). This additional space can be used to provide an additional concentrating lens. For example, if the tilted concentrating lens resulted in a 20 percent space reduction that provided the same amount of concentrated light, a fifth concentrating lens could be fit into a footprint where only four concentrating lenses would have previously fit.

In the example of FIG. 2, the light exiting surface 204 includes the canted faces 206 and the light receiving side 202 is generally flat. However, in alternative examples, the light exiting surface can be generally flat and the light receiving side can include the canted faces. In yet other alternative examples, each of the light receiving surfaces and the light exiting surfaces can include a mix of canted faces and generally flat regions.

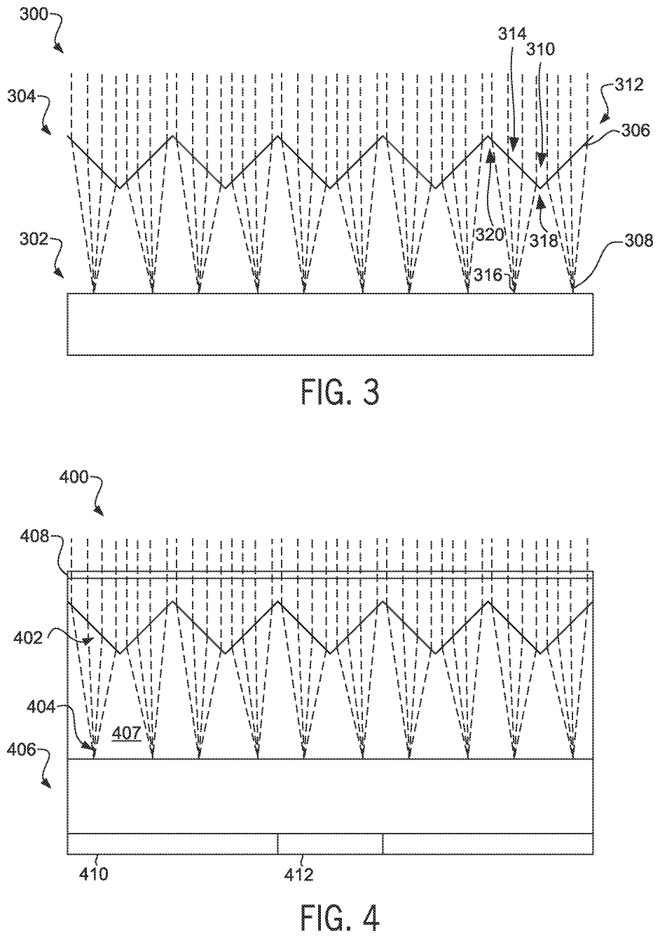

FIG. 3 depicts an example of a light concentrating apparatus 300. In this example, the concentrator apparatus 300 includes a light receiver 302 and a light concentrator 304 with multiple light concentrating lenses. For purpose of clarity, the specific lens geometric details of each concentrating lens are not shown in FIG. 3. The light concentrator 304 includes a first concentrating lens 306 with a first focal point 308 on the light receiver 302. A first side 310 of the first concentrating lens 306 is closer to the first focal point 308 than a second side 312 of the first concentrating lens 306. Thus, the first light concentrating lens 306 is offset and focuses the light rays to an off-centered focal point. With the first light concentrating lens 306 being asymmetrically positioned around the first focal point 308, the first light concentrating lens' footprint is smaller than a traditional Fresnel lens that would be symmetrically oriented about the focal point.

The light concentrating apparatus 300 also includes a second light concentrating lens 314. In this example, the second light concentrating lens 314 is also asymmetrically oriented about a second focal point 316. Thus, a first side 318 of the second light concentrating lens 314 is closer to the second focal point 316 than a second side 320 of the light concentrating lens 314. In this example, the second light concentrating lens 314 is transversely oriented with respect to the first light concentrating lens 306. Thus, the first and second light concentrating lenses 306, 314 form a non-180 degree angle.

The angle formed between the first and second light concentrating lenses 306, 314 can be any appropriate angle. In some examples, the angle is greater than 5 degrees, greater than 10 degrees, greater than 15 degrees, greater than 20 degrees, greater than 25 degrees, greater than 30 degrees, greater than 40 degrees, greater than 45 degrees, greater than 50 degrees, greater than 60 degrees, greater than 70 degrees, greater than 80 degrees, greater than 90 degrees, greater than 100 degrees, greater than 105 degrees, greater than 110 degrees, greater than 120 degrees, greater than 130 degrees, greater than 140 degrees, greater than 150 degrees, greater than 160 degrees, greater than 170 degrees, greater than another appropriate degree, or combinations thereof.

In the example depicted in FIG. 3, the first focal point 308 and the second focal point 316 are spaced apart from one another at a distance. The first and second focal points 308, 316 can be spaced apart at any appropriate distance. In some examples, the first and second focal points 306, 316 are spaced apart at a distance of less than 1.0 inch, less than 2.0 inches, less than 3 inches, less than 5 inches, less than 7 inches, less than 10 inches, less than 15 inches, less than 20 inches, less than 25 inches, less than another appropriate distance, or combinations thereof. In some examples, the first and second light concentrating lenses 306, 314 focus light at the exact same point on the light receiver 302.

In those examples where both the first and second light concentrating lenses 306, 314 are offset, the footprint reduction of the tilted lenses is additive. Thus, the benefit of a greater amount of light can be concentrated to the light receiver 302 in a smaller area. Additional light concentrating lenses can be added to the freed space available around the light receiver 302, which increases the overall amount of light concentrated to the light receiver 302.

In the depicted example, a plurality of light concentrating lenses forms a zig-zig cross section. While the example in FIG. 3 depicts each of the light concentrating lenses oriented to form a symmetrical cross section, at least one of the light concentrating lenses can be oriented such that it is orientated at a different offset angle than at least two other lenses in the plurality of light concentrating lenses. Further, while the example in FIG. 3 depicts each of the concentrating lenses having the same length or dimensions, in alternative examples, at least one of the concentrating lens has a different length than at least one of the other concentrating lenses.

The light receiver 302 can be any appropriate object or fluid. In one example, the light receiver 302 is a solar cell that converts light energy into electrical energy. By focusing more light on the solar cell within an area, the solar cell can convert more electricity in the same area. Thus, the productivity of the solar cell can be increased without increasing the footprint of the solar cell and/or the concentrating apparatus. In those examples, where the concentrating apparatus is part of a solar farm, the solar farm can be more productive without increasing the solar farm's footprint.

In another example, the light receiver 302 can be pipe or another type of conduit that can hold and/or carry a gas or a fluid. In some examples, the fluid is a gas. In other examples, the fluid is a water-based liquid and/or an oil based liquid. Individual homes, buildings, or communities can use the light concentrator apparatus to heat water. Such heated water can be used to run showers, dishwashers, washing machines, or other home-based or industry-based applications. In yet other examples, the water can be converted into steam which can be used to power a turbine for electricity generation. In yet another example, the heated water can be used in a heat exchanger that can be used to heat or cool a building, generate electricity, heat a pool, heat sidewalks, heat driveways or roads, regulate a climate within a building, heat other objects, regulate the temperature of other objects, or combinations thereof.

In another embodiment, the light receiver 302 can be any article where a transfer of thermal energy is desired. For example, the light receiver can be an article of clothing; a building element such as a roof, window, or wall; a tent surface; an automobile surface; a boat surface; or any other structural element. Additionally, the light concentrator apparatus can assume any appropriate size to effectively and efficiently transfer thermal energy to the desired article. In one embodiment, the light concentrator apparatus includes a plurality or an array of light concentrator lenses. The light concentrator lenses can be a micro array of lenses that can be incorporated into any environment, including clothing.

FIG. 4 depicts an example of a light concentrator apparatus 400. In this example, the light concentrator apparatus 400 includes concentrating lenses 402 that alternate with offset angles with respect to each other. In this example, each of the offset alternating lenses 402 directs light to offset focal points 404 on a light receiver 406. However, in alternative examples, the concentrating lenses 402 can direct at least two of the focal points to the same location.

In the depicted example, the space between the light concentrating lenses 402 and the light receiver 406 is enclosed. In some examples, this enclosed space 407 is filled with an inert or other gas that controls the light transmitting environment. In these examples, the enclosure can prevent dust, debris, or other optical interfering particles from lowering the efficiency of the light transmission from the light concentrating lenses 402 to the light receiver 406. While this example has been described with an enclosure, in alternative embodiments, the light concentrating apparatus does not include an enclosure and air or other gases can pass through the space between the light concentrating lenses and the light receiver.

In another example, the space between the light concentrating lenses 402 to the light receiver 406 can be under a partial vacuum. In this example, the partial vacuum can maintain an environment that is unimpeded as much as possible from gas molecules that could interfere with the transmission of light or at least has that amount of gas reduced from that of ambient conditions. Light travels faster through a vacuum than light travels through a solid, liquid, or gaseous transparent media. This slowing down of light through transparent media is a form of energy transport and involves the absorption and reemission of the light energy by the atoms of the substance. Some of the energy of the light is lost in the absorption and reemission through the transparent substance's molecules. In some cases, this energy loss can be evidenced by a temperature rise in the transparent material.

A complete vacuum can be difficult to achieve on earth's surface. Thus, in some cases, a partial vacuum can be used. To create at least a partial vacuum, the air in the enclosure formed at least in part by the concentrating lenses and the light receiver can be removed with a vacuum pump to achieve a reduced pressure environment, less than environmental pressure, and in one example, less than 1 atm. The enclosure can be made of any appropriate type of material. A non-exhaustive list of materials that can be used include stainless steel, aluminum, mild steel, brass, high density ceramics, glass, acrylic, other types of materials, or combinations thereof.

The light concentrator apparatus 400 can also include a protective transparent barrier 408 that protects the light concentrating lenses 402 from debris or other at least partially opaque materials that could lower the light concentrating lenses transparency. According to one embodiment, the protective transparent barrier 408 can be included on any of the systems disclosed herein, and can include a coating that adds chemical resistance, flexibility, weather, and UV stability. In one embodiment, the transparent barrier is an aliphatic coating, more specifically, an aliphatic urethane coating or an aliphatic polyurethane coating. This coating can increase weathering performance of the surface of the light concentrator apparatus 400, and prevent haze or other obscuring elements that can reduce the efficiency and light transmissibility of the light concentrator apparatus. Light can pass through the protective transparent barrier 408 with or without a refractive change. While the example depicted in FIG. 4 is a substantially flat barrier, the barrier can include any appropriate shape or orientation.

In the illustrated example, the light receiver 406 can also be a pipe that carries a dynamic or stationary fluid. In some cases, the light receiver 406 can be a material with a high heat capacity that retains heat. In those examples where the light receiver 406 transfers heat to a flowing dynamic fluid, the fluid can be heated as it travels through the interior of the pipe. The heated fluid can be used for a useful application after exiting the light receiver 406. In some cases, the light receiver is a porous material through which fluid can be passed. The porous material can increase the surface area that the fluid has with the fluid to improve the thermal transfer. In yet other embodiments, the light receiver 406 includes multiple pipes and/or multiple fluid flow paths within the light receiver 406 to increase the thermal transfer.

The light receiver 406 can be any appropriate color. In some examples, the light receiver 406 includes a black or at least a dark surface to absorb the light. Alternatively, the light receiver 406 can be transparent to allow all of the thermal energy focused by the light concentrating lenses to be passed to the fluid contained therein.

A heat spreader can be incorporated into the light receiver 406. The heat spreader can be made of a thermally conductive material such that hot spots on the light receiver 406 are minimized. Generally, the temperature of the entire heat spreader is relatively uniform since the heat can be spread throughout the entire material. In some cases, the heat spreader is made of a metal or a thermally conductive ceramic. In yet other examples, the entire light receiver 406 is made of a thermally conductive material that minimizes the hot spots by spreading the thermal energy from the focal points throughout the light receiver's material.

An insulation layer 410 can surround the light receiver to trap heat in the light receiver 402. The insulation layer 410 can be made of any appropriate material and have any appropriate thickness. In some cases, the insulation layer includes a reflective surface to further deflect the heat back into the light receiver 406.

In some cases, a heat exchanges 412 and/or absorber can be incorporated into the insulation layer 410. The heat exchanger 412 can be used to transfer the heat in the light receiver 406 to a productive application. In some examples, the heat exchangers 412 are conductive heat exchangers that transfer heat through conduction. These types of heat exchangers can be metal incorporated into the insulation layer 410. In other examples, the heat exchanges can transfer heat through convection.

While the depicted examples have been described with reference to a single light receiver, the light concentrating lenses can project focal points onto multiple light receivers within the light concentrating apparatus.

FIG. 5 depicts an example of a light concentrating apparatus 500 having a transparent protective barrier 502 over a first light concentrating lens 504 and a second light concentrating lens 506. Each of the first and second light concentrating lenses 504, 506 direct their respective focal points to the same location 508 on a light receiver 510. In this example, the light receiver 510 is a cooking pan. The heat from the light can be used to cook food in the cooking pan. In this example, there is no closed off enclosure between the light concentrating lenses 504, 506 and the light receiver 510.

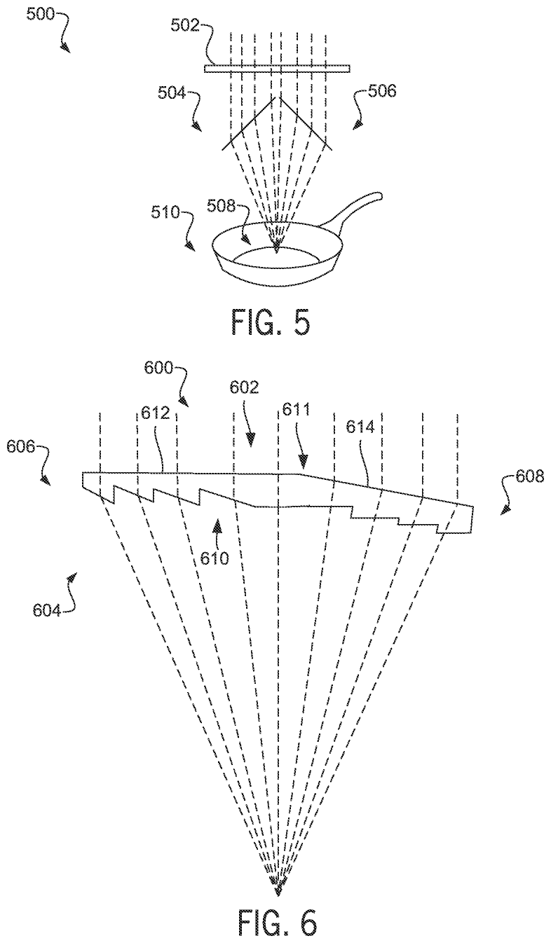

FIG. 6 depicts an alternative example of a light concentrating lens 600. In this example, the light concentrating lens 600 includes a light receiving surface 602 and a light exiting surface 604. A first side 606 of the light concentrating lens 600 connects the light receiving surface 602 and the light exiting surface 604. A second side 608 of the light concentrating lens 600 is opposite the first side and also connects the light receiving surface 602 and the light exiting surface 604. The light exiting surface 604 includes canted faces 610 that form refractive surfaces.

The light receiving surface 602 includes a bend 611 separating a first flat surface 612 and a second flat surface 614 that are contiguous, but still a single piece of material. The first flat surface 612 defines in part a first focal plane, and the second flat surface 614 defines in part a second focal plane. The bend 611 forms an angle. As a result, as parallel light rays enter the light receiving surface 602, the light rays entering the first flat surface 612 experience a different refractive change than the light rays entering the second flat surface 614. Thus, the canted surfaces opposite the first flat surface 612 have a different set of refractive angles than the canted surfaces opposite the second flat surface 614 to focus all the light rays on a single focal point.

The bend 611 can form any appropriate angle. For example, the bend can form an angle that is less than 5 degrees, less than 10 degrees, less than 15 degrees, less than 20 degrees, less than 25 degrees, less than 30 degrees, less than 35 degrees, less than 40 degrees, less than 45 degrees, less than 55 degrees, less than 65 degrees, less than 75 degrees, less than 90 degrees, less than another appropriate degree, or combinations thereof.

While this embodiment is depicted with just first and second flat surfaces, any number of flat surfaces can be used in accordance with the principles described herein. For example, the light receiving surface can include a first bend and a second bend that causes the relative slope of the light receiving surface to get steeper and steeper.

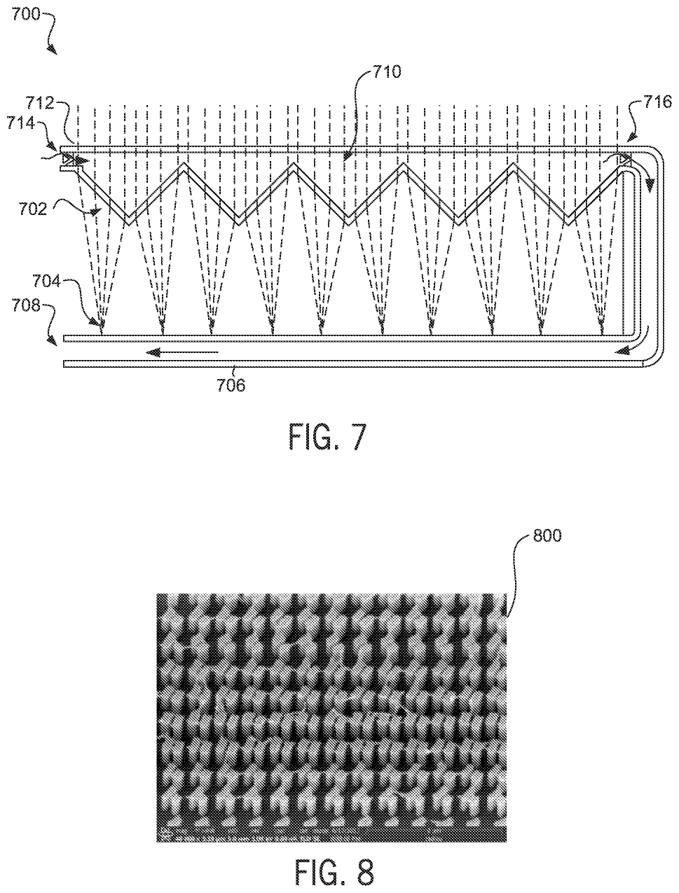

FIG. 7 depicts an example of an alternative light concentrator apparatus 700. In this example, the light concentrator apparatus 700 includes concentrating lenses 702 that alternate with offset angles with respect to each other, as discussed above. In this example, each of the offset alternating lenses 702 directs light to offset focal points 704 on a light receiver 706.

The light receiver 706 can be a photovoltaic cell, clothes, a container, a building component, etc. However, as shown in FIG. 7, the light receiver 706 can be a pipe that forms a part of a pathway configured to accommodate a flow of fluid. The light receiver 706 can receive fluid, such as oil, water, a gas, or another type of fluid, from any appropriate source. The pathway can route the fluid through any appropriate pathway. In the illustrated example, a first portion 708 of the pathway is formed in the light receiver 706. A second portion 710 of the pathway is defined in part by the alternating concentrating lenses 702. The second portion 710 of the pathway can also be partially defined by a transparent material, collectively defining a fluid pathway.

The transparent material 712 and the concentrating lenses 702 can define a space that constitutes the second portion 710 of the pathway. A first valve 714 can control a flow of fluid entering the second portion 710 of the pathway, and a second valve 716 can control a flow of fluid exiting the second portion 710 of the pathway. The fluid pressure within the second portion 710 can be adequate to reduce unfilled space within the second portion 710 and can include exhaust ports (not shown) or other features intended to eliminate any bubbles or other impurities that can affect the efficiency of the light concentrator apparatus 700. Each optical boundary within the second portion 710 can cause at least a small amount of refraction. Further, refraction can occur when the surface of a liquid enters the second portion 710 of the pathway because the liquid's inertia from entering the second portion 710 can cause the surface angle to dynamically change. By controlling the fluid pressure within the second portion 710 so that no unfilled gaps are present, the number of optical boundaries and be reduced and their angles can be controlled and the liquid forms an integral part of the lens in the second portion 710.

The solar energy transmitted through the transparent material 712 can heat the fluid while the fluid is in the second portion 714 of the pathway. When the fluid reaches the first portion 708 of the pathway, the fluid's temperature can raise even more since the solar energy is concentrated on the light receiver 706. In this manner, the fluid can be heated in at least two stages.

While the examples above have been described with the canted surfaces being on the light exiting surface of the concentrating lens, in some examples, canted faces are incorporated into the light receiving surface. In these types of examples, the canted faces are incorporated into both the light receiving surface and the light exit surface. In other examples, the canted faces are just incorporated into the light receiving surface.

Alternatively, while the above examples have been described in the context of using angled refractive surfaces to controllably direct light through a lens onto a desired object, any number of light refractive or modifying geometries or surfaces can be used to predictably direct light received by a light receiving surface. According to one exemplary embodiment, meta-optics can be used to controllably direct light, according to the present exemplary system, either for use with a solar panel, for heating, or for other light focusing purposes. The meta-optics can include one or more ultrathin arrays of tiny waveguides, known as meta-surfaces, which bend at least visible light as it passes there through. FIG. 8 illustrates a scanning electron microscope image of exemplary meta-optics. As illustrated in FIG. 8, the meta-optics lens 800 can be formed to be a flat panel, either with or without the formation of a chamber for multiple stage heating, as described above. The waveguide meta-surfaces can be made of any number of materials that can strongly confine light with a high refractive index, including, but in no way limited to, titanium dioxide, a silver dioxide, or graphene. Additionally, the meta-surfaces can be formed and organized or tuned to selectively and precisely focus received light on a desired surface. The meta-surfaces can be formed using any number of additive or subtractive methods, including, but in no way limited to, patterning, dry or wet etching, electron beam lithography, and/or 3-D printing. Accordingly, compared to traditional lens systems, weight and thickness can be reduced while providing an increased efficiency.

While various uses and configurations of the present systems have been individually described above, each of the systems and configurations can be combined to create hybrid systems. For example, the fluid filled second portion 710 shown in FIG. 7 can be incorporated with a photovoltaic light receiver 706 in a single system. According to this system, a fluid can be heated in the fluid filled second portion 710, while efficiently transmitting and focusing light to the photovoltaic light receiver 706. Additionally, the described components can be combined in various configurations and sizes (from macro levels to micro scale) to be applied to any number of environments and targets, including, but in no way limited to, heating clothes, tents, buildings and building components, windows, vehicles, cooking appliances, heat pumps, sterilization systems, and any other thermal energy consuming systems.

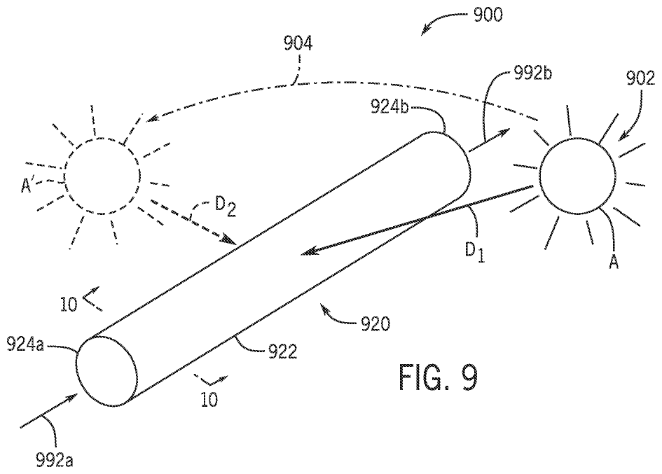

The concentrating lenses of the present disclosure can be implemented in a variety of other concentrator apparatuses and solar optical collection systems more generally. For example, the concentrating lenses can be implemented in a concentrating apparatus that is adapted to concentrate solar radiation that is received from a plurality of different incident angles. With reference to FIG. 9, an isometric view of an example system 900 including a concentrator apparatus 920 is shown. The concentrator apparatus 920 can be adapted to receive solar radiation from a plurality of different incident angles and concentrate the solar radiation onto a heat transfer medium. A plurality of the concentrating optical lenses can define an arrangement with the concentrator apparatus 920 that allows at least a subset of the lenses to receive solar radiation. This can allow the concentrator apparatus 920 to receive solar energy as the sun moves along a day arc.

By way of schematic illustration, FIG. 9 shows sun 902 relative to the concentrator apparatus 920. The sun 902 can generally move along day arc 904 between a first position A and a second position A′. The sun 902 can emit solar radiation along a direction D₁ when the sun 902 is in the first position A. The sun 902 can emit solar radiation along a direction D₂ when the sun 902 is in the second position A′. The concentrator apparatus 920 can be adapted to receive solar radiation from the sun 902 from the first direction D₁ and the second direction D₂ and direct and concentrate the solar radiation to a heat transfer medium held within the concentrator apparatus 920. The solar radiation can be received without moving or manipulating the lens and other optical components of the concentrator apparatus 920.

The concentrator apparatus 920 is shown in the schematic view of FIG. 9 as having a substantially cylindrical body 922. The cylindrical body 922 can define a pipe, tube, conduit, or other structure that allows the concentrator apparatus 920 to direct a heat transfer medium between an input end 924a and an output end 924b of the concentrator apparatus 920. At the input end 924a, the concentrator apparatus 920 can receive an input flow 992a. At the output end 924b, the concentrator apparatus 920 can emit an output flow 992b.

A heat transfer medium can be introduced to the concentrator apparatus 920 at the input end 924 via the input flow 992a. The heat transfer medium can receive thermal energy from the sun 902 via the concentrator apparatus 920. The heat transfer medium can receive thermal energy in concentrated form from the sun 902 notwithstanding a position of the sun 902 along the day arc 904. To illustrate, the heat transfer medium can receive thermal energy from the sun 902 when the sun 902 is in the first position D₁. The heat transfer medium can also receive thermal energy from the sun 902 when the sun 902 is in the second position D₂. In some cases, the heat transfer medium can receive thermal energy from the sun 902 at substantially any position of the sun 902 along the day arc 904. The concentrator apparatus 920 can therefore be configured to receive the thermal energy transfer throughout the day and without moving or otherwise manipulating the lenses or other optical components of the concentrator apparatus 920.

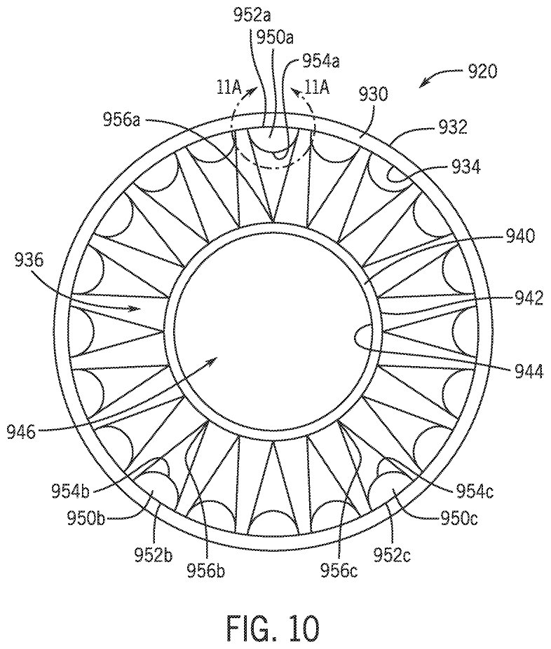

To facilitate the foregoing, the concentrator apparatus 920 includes an outer member 930, an inner member 940, and an arrangement of concentrating lenses 950, as shown in the cross-sectional view of FIG. 10. The outer member 930 can be a first portion of the concentrator apparatus 920 that is adapted to receive thermal energy therethrough. The outer member 930 includes an outer member first surface 932 and an outer member second surface 934. The outer member 930 can be a transparent or partially transparent structure that receives light though a thickness of the outer member 930 that is defined between the outer member first surface 932 and the outer member second surface 934. The outer member 930 can be a substantially cylindrical component and define a tube or pipe that extends along an axis of the concentrator apparatus 920.

The inner member 940 can be a second portion of the concentrator apparatus 920 that is adapted to surround a heat transfer medium. The second portion can be a light receiver that receives the solar radiation from the surrounding optical lenses. For example, the inner member 940 include, define or be associated with a pipe or tube that defines an inner volume 946. The inner member 940 includes an inner member first surface 942 and an outer member second surface 944. The inner member first surface 942 and the outer member second surface 944 can define opposing surfaces of pipe, for example, with the inner volume defined therein.

In one example, the member 940 can be at least partially formed from a copper tubing. Copper tubing can reduce the overall cost of the system while providing heat-absorbing characteristics adapted to transfer energy to heat transfer medium in the volume, such as having a thermal conductivity of around 386.0 W/m-C, as one example. The copper tubing can be coated with paint designed for high temperatures. One example paint includes the Thurmalox® line of coatings manufactured by the Dampney Company of Everett, Mass. In this regard, the inner member 940 can be substantially heat resistant, such as being heat resistant to temperatures as high as 500 degrees Fahrenheit, or higher. The coating can also be applied to selected portions of the outer member 930, as can be appropriate for a given application.

In the example of FIG. 10, the outer member 930 and the inner member 940 are shown as substantially concentric components. An annular region 936 can be defined substantially between the outer member 930 and the inner member 940. The annular region 936 can optionally be under a vacuum or partial vacuum. While the annular region 936 is shown in FIG. 10 as being substantially symmetric about a longitudinal axis of the concentrator apparatus 920, other shapes and arrangements are contemplated herein. For example, one or both of the inner member 940 and the outer member 930 can be shaped into a coil, such as a tight coil. The coil can wrap around and extend into a center of the coil in order to mitigate thermal energy escaping. The coil can be a 3D printed coil using printable stainless steel, as one example. An example material include the Corrax® product distributed by Uddeholm USA of Elgin, Ill. In this regard, the annular region 936 can be any appropriate shaped defined between the inner and outer members 930, 940.

The inner and outer members 930, 940 can be adapted to hold the arrangement of lenses 950 therebetween. For example, the inner and outer members 930, 940 can be adapted to hold the arrangement of lenses 950 within the annular region 936. With reference to FIG. 10, an illustrative first concentrating lens 950a is shown having a lens first surface 952a and a lens second surface 954b. The lens first surface 952a can be associated with the outer member 930. For example, the lens first surface 952a can be arranged adjacent or otherwise substantially facing the outer member 930. The lens second surface 954a can be associated with the inner member 940. For example, the lens second surface 954a can be arranged adjacent or otherwise substantially facing the inner member 940.

The first concentrating lens 950a can broadly be configured to receive solar radiation through the outer member 930 at the lens first surface 952a. The first concentrating lens 950a can be a refractive lens, such as any of the lenses described herein. The first concentrating lens 950a can more generally be configured to receive the solar radiation and direct the solar radiation to the lens second surface 954a where the solar radiation is emitted toward the inner member 940. The solar radiation can be concentrated via its propagation through the first concentrating lens 950a. As one example, the lens second surface 954a can define a plurality of refractive surfaces that direct the solar radiation toward a common focal point when the radiation is emitted from the first concentrating lens 950a. In other cases, the lens second surface 954a can include one or more substantially smoothly or otherwise continuous and contoured surfaces that transition light toward a common focal point for concentration on the inner member 940. In the present example, the solar radiation is propagated from the lens second surface 954a and toward a first focal point 956a. The first focal point 956a can be defined substantially on the inner member 940, as shown in FIG. 10. In other cases, the first focal point 956a can be defined substantially within a body of the inner member 940, including being within the inner volume 946. The first focal point 956a can be tuned based on an effective focal length of the first concentrating lens 950a. Focal lengths of around 15 mm to 25 mm can be used.

The arrangement of concentrating lens 950 can include any appropriate number of concentrating lenses in order to facilitate the omnidirectional concentration of light on the inner member 940 or light receiver. For example, the concentrating lenses 950 can be positioned about the inner member 940, such as about circumference of the inner member 940. In some cases, the concentrating lenses 950 can be substantially evenly circumferentially spaced about the inner member 940. This arrangement can allow a subset of the concentrating lenses 950 to receive solar radiation from the sun 902 as the sun travels through the day arc 904, as at least one or more of the concentrating lenses 950 substantially directly faces the sun 902 for a given position of the sun 902 along the day arc 904. In this regard, it will be appreciated that any appropriate number of concentrating lenses 950 can be integrated with the concentrator apparatus 920 in order to capture solar radiation from a variety of different azimuths and altitudes of the sun 902. In the illustrated example, 20 concentrating lenses are provided. However, in other cases, more or fewer lenses can be provided, such as providing at least 30 lenses, at least 50 lenses, at least 70 lenses, at least 100 lenses, or more about the inner member 940.

Each lens of the arrangement of concentrating lenses can be adapted to concentrate light toward a focal point on or adjacent the inner member 940. Each concentrating lens of the arrangement can have a respective focal point. For purposes of illustration, a second concentrating lens 950b is shown having a lens first surface 952b and a lens second surface 954b. A third concentrating lens 950c is shown having a lens second surface 952c and a lens second surface 954c. The second and third concentrating lenses 950b, 950c can be substantially analogous to the first concentrating lens 950a. The second concentrating lens 950b can be adapted to collect and direct light toward a second focal point 956b. The third concentrating lens 950c can be adapted to collect and direct light toward a third focal point 956c.

The first, second, and third focal points 956a, 956b, 956c can each be different points on the light receiver or inner member 940. For example, the first, second, and third focal points 956a, 956b, 956c can be circumferentially spaced about the inner member 940 generally corresponding to the circumferential spacing of the concentrating lenses. In other cases, one or more of the concentrating lenses can be arranged such that one or more or all of the focal points of the concentrating lenses overlap with one another.

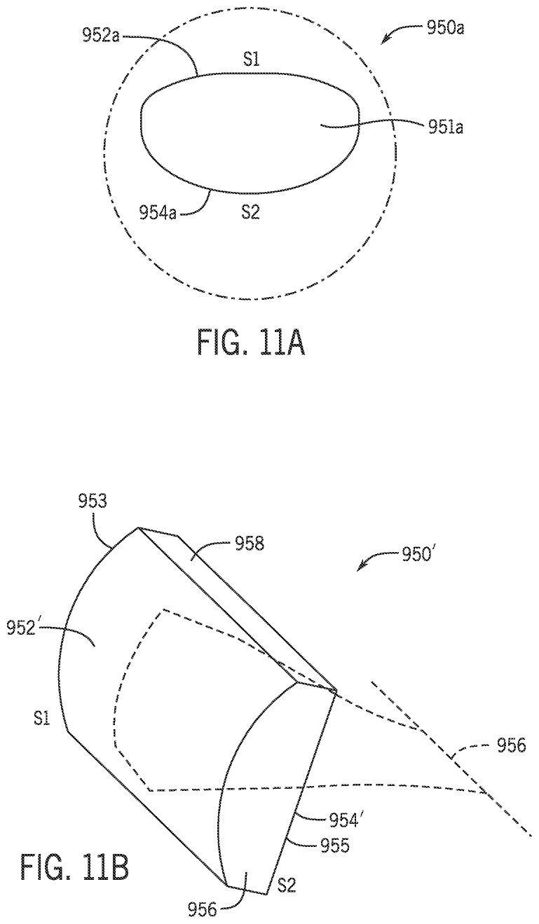

FIG. 11A illustrates a detail view 11A-11A of the concentrating lens 950a. The concentrating lens 950a includes a lens body 951a. The lens body 951a can define a substantially cylindrical rod lens. The rod lens includes a surface contour S1 defined on the lens first surface 952a. The rod lens includes a surface contour S2 defined on the lens second surface 954a. The first and second surface contours S1, S2 can be optimized for solar radiation concentration by modeling the rod lens as biconic or a similar type surface. Compared to a rotationally symmetric conic surface, the biconic surface has two more degrees of freedom with different curvature and conic parameters in the x and y direction. The surface contours S1, S2 can thus be tuned in a manner analogous to the correction of primary aberrations, such as spherical aberration, coma and primary astigmatism, as well as secondary astigmatism. In some cases, a half Maddox optics structure can be utilized. Additionally or alternately, one or both of the surface contours S1, S2 can include a plurality of refractive surfaces, such that described with the concentrating lens of FIGS. 1-8.

With respect to the example of a cylindrical rod lens, FIG. 11B presents as isometric view of another concentrating lens 950′. In the example of FIG. 11B, a first surface contour S1 is defined by a substantially cylindrical portion 953. Further, a second surface contour S2 is defined by a projection portion 955 opposite the substantially cylindrical portion 953. In some cases, the projection portion 955 can be tuned to emit radiation toward a focal axis 956. For example, the projection portion 955 can define one or more refractive surfaces that direct light for convergence on the focal axis 956.

FIG. 11B further shows the concentrating lens 950′ having an axial face 959. Multiple concentrating lenses can be arranged with one another along an axis of the concentrator apparatus. In some cases, the concentrating lenses can be connected end-to-end, with the axial face 959 of the concentrating lens 950′ engaged with an axial face of another concentrating lens. This can be beneficial for defining an axial length of the focal axis along an entire run of pipe or other light receiver that contains the heat transfer medium. The concentrating lens 950′ can also include a circumferential face 958. As described herein, the concentrating lenses can be arranged circumferentially about the light receiver. In this regard, the concentrating lens 950′ can be connected with other lenses side-by-side, with the circumferential face engaged with a circumferential face of another concentrating lens.

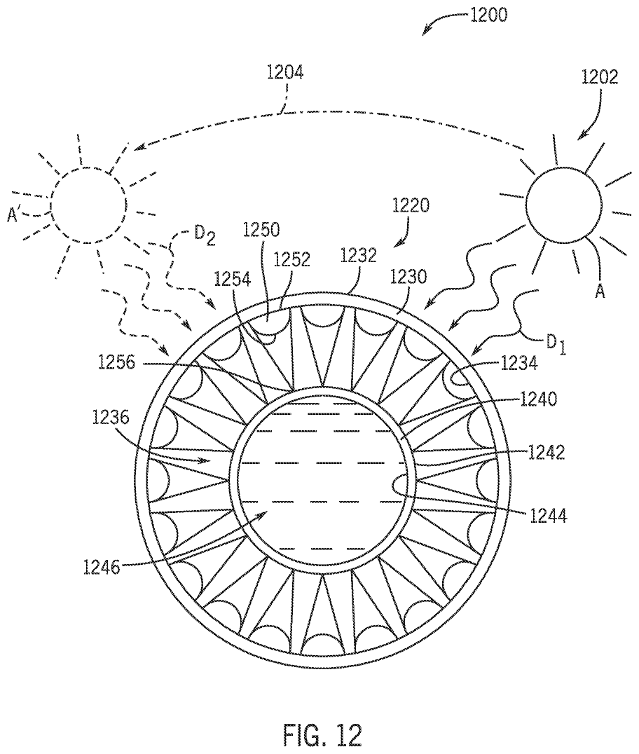

With reference to FIG. 12, a system 1200 is shown including a cross-sectional view of a concentrator apparatus 1220. The system includes sun 1202 in a first position A and a second position A′. The first and second positions A, A′ can be arranged along a day arc 1204. The sun 1202 emits solar radiation in a first direction D₁ in the first position A. The sun emits solar radiation in a second direction D₂ in the second position A′. The concentrator apparatus 1220 can be substantially analogous to the concentrator apparatus 920 described above with reference to FIGS. 9-11B and include: an outer member 1230, an outer member first surface 1232, an outer member second surface 1234, a vacuum 1236, an inner member 1240, an inner member first surface 1242, an outer member second surface 1244, a fluid volume 1246, a concentrating lens 1250, a lens first surface 1252, lens second surface 1254, and a focal point 1256; redundant explanation of which is omitted for clarity.

FIG. 12 shows the concentrator apparatus including a transfer medium 1260 within the fluid volume 1246 of the inner member 1240. The transfer medium 1260 can be any appropriate fluid that is configured to receive thermal energy through the concentrator apparatus 1220 and store the thermal energy for subsequent use. For example, the transfer medium 1260 can have an initially cooler temperature upon entering the concentrator apparatus 1220. The transfer medium 1260 can receive thermal energy within the fluid volume 1246. The heat transfer medium 1260 can receive thermal energy notwithstanding the position of the sun 1202 along the day arc 1204. For example, when the sun 1202 is in the first position A, the arrangement of concentrating lenses cooperate to receive and concentrate energy toward the fluid volume 1246 and the transfer medium 1260 held therein. Further, when the sun 1202 is in the second position A′, the arrangement concentrating lenses cooperate to receive and concentrate energy toward the fluid volume 1246 and the transfer medium 1260. In turn, the transfer medium 1260 can exit the concentrator apparatus 1220 have a raised temperature, such as being a temperature that is increased, including being substantially increased, from a temperature of transfer medium upon entry into the concentrator apparatus 1220. The thermal transfer medium 1260 can be subsequently routed to other components of a thermal system to extract the energy from the transfer medium 1260. As one example, the transfer medium 1260 can be routed to a heat exchanger in which the energy from the transfer medium 1260 is used to heat a household water supply. While many fluid are possible and contemplated herein, sample transfer medium include: one or more of water, a glycol/water mixture, hydrocarbon oils, refrigerants/phase change fluids, silicones, molten salts, a molecular solar thermal energy storage, or a zeolite-based thermal storage.

In some examples, the various concentrator apparatuses of the present disclosure can be incorporated into an energy collection system that is operable to collect energy from multiple different energy sources. For example, the concentrator apparatuses can be incorporated into an energy collection system that is adapted to collect both solar and wind energy. Solar and wind energy can be captured substantially simultaneously with the same apparatus. This can enhance the energy collection density of the system while the overall system is footprint is reduced.

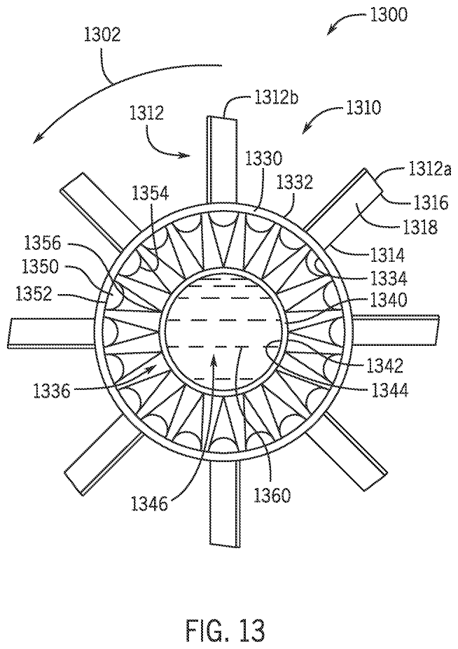

With reference to FIG. 13, an example energy collection system 1300 is shown. The energy collection system 1300 is configured to capture solar energy and wind energy. With regard to solar energy capture, the energy collection system 1300 includes a concentrator apparatus 1320. The concentrator apparatus 1320 can be substantially analogous to the concentrator apparatus 920 and 1220 and include: an outer member 1330, an outer member first surface 1332, an outer member second surface 1334, a vacuum 1336, an inner member 1340, an inner member first surface 1342, an outer member second surface 1344, a fluid volume 1346, a lens 1350, a lens first surface 1352, a lens second surface 1354, a focal point 1356, and a transfer medium 1360; redundant explanation of which is omitted herein for clarity.

Notwithstanding the foregoing similarities, the system 1300 further includes a catch mechanism 1310 that is adapted to collect wind energy 1302. The catch mechanism 1310 can be associated with the outer member 1330 of the concentrator apparatus 1320 and generally be capable of rotating with the movement of the wind 1302. For example, the concentrator apparatus 1320 can be constructed such that the outer member 1330 is movable relative to the inner member 1340. In some cases, the outer member 1330 can float relative to the inner member 1340. In this regard, the catch mechanism 1310 can be integrated with the outer member 1330 to collect the wind energy 1302 and facilitate movement of the outer member 1330. The movement of the outer member 1330 can in turn be used to generate an electrical current for power storage.

To facilitate the foregoing, the catch mechanism 1310 includes a plurality of blades 1312, such as the first blade 1312a and the second blade 1312b shown in FIG. 13. The plurality of blades 132 can be circumferentially spaced about the outer member 1330. One or more or all of the blades 1312 can be aerodynamic blades that are configured to generate lift upon receipt of airflow thereacross. In the example of FIG. 13, the first blade 1312a includes a blade body 1318 extending between a blade distal end 1316 and a blade proximal end 1314. The blade body 1318 can define an aerodynamic shape. The blade proximal end 1314 can extend from the outer member 1330. The blade distal end 1316 can be a free end of the blade 1312a. The blade proximal end 1314 can be fixed rigidly to the outer member 1330. In this regard, movement of the blade 1312 can cause movement of the outer member 1330. Movement of the outer member 1330 can be used to generate an electrical current that can be storage for subsequent power consumption. The arrangement of concentrating lenses can continue to provide the omnidirectional concentration of light on the light receiver while the catch mechanism 1310 collects wind energy 1302.

The substantially lightweight and compact design of the concentrator apparatuses of the present disclosure can enhance the adaptability of the concentrator apparatus for installation in variety of locations. For example, the concentrator apparatuses can utilize existing infrastructure for installation in locations that receive sufficient solar radiation. This can decrease installation costs by avoiding the construction of new, standalone facilities to support the concentrator apparatus.

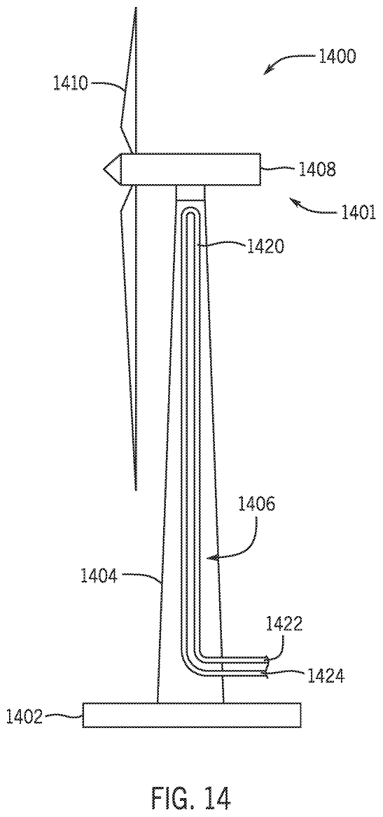

With reference to FIG. 14, an example system 1400 is shown including a concentrator apparatus 1420 installed with a wind turbine 1401. The concentrator apparatus 1420 can be substantially analogous to the concentrator apparatus 920 and 1220 described herein. For example, the concentrator apparatus 1420 can utilize an arrangement of concentrating lenses to facilitate the omnidirectional concentration of light toward a light receiver. In this regard, a transfer medium can be introduced to the concentrator apparatus 1420 at a transfer medium inlet 1422. The transfer medium can receive thermal energy via the arrangement of concentrating lenses. The transfer medium can exit the concentrator apparatus 1420 having an increased temperature at the transfer medium outlet 1424.

The wind turbine 1401 can be a system that is used to capture wind energy. The concentrator apparatus is installed on the structure of the wind turbine 1401, thereby utilizing the footprint and structure of the wind turbine for solar energy capture. In the example of FIG. 14, the wind turbine includes a base 1402 and a tower 1404 extending from the base 1402. The tower 1404 can have a tower surface area 1406. The concentrator apparatus 1420 can be installed with the wind turbine 1401 at the tower surface area 1406. As one example, the concentrator apparatus 1420 can extend along a height of the tower 1404; however, other configurations are possible. The wind turbine 1401 is further shown in FIG. 14 as having a motor assembly 1408 and a blade assembly 1410.

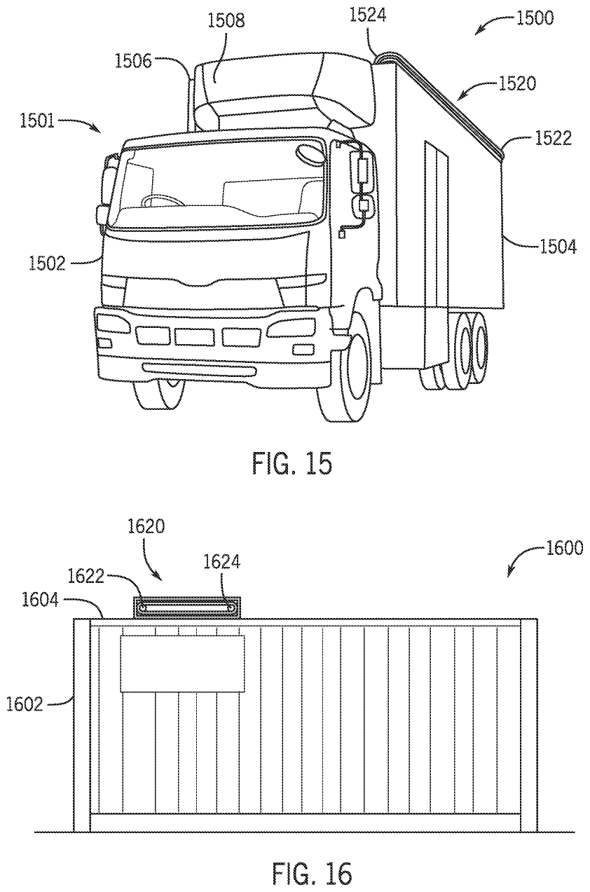

With reference to FIG. 15, an example system 1500 is shown including a concentrator apparatus 1520 installed with a truck 1501. The concentrator apparatus 1520 can be substantially analogous to the concentrator apparatus 920 and 1220 described herein. For example, the concentrator apparatus 1520 can utilize an arrangement of concentrating lenses to facilitate the omnidirectional concentration of light toward a light receiver. In this regard, a transfer medium can be introduced to the concentrator apparatus 1520 at a transfer medium inlet 1522. The transfer medium can receive thermal energy via the arrangement of concentrating lenses. The transfer medium can exit the concentrator apparatus 1520 having an increased temperature at the transfer medium outlet 1524.

The truck 1501 can include a cab 1502 and a trailer 1504. In some cases, the truck 1501 can be a refrigeration truck having a refrigeration unit 1508. The concentrator apparatus 1520 can be installed on a trailer top surface 1506 of the trailer 1504. In some cases, the concentrator apparatus 1520 can be integrated with the refrigeration unit 1508 in order to help drive a thermoelectric cooling system. For example, the concentrator apparatus 1520 can be used to drive a thermoelectric cooling system that uses the Peltier effect to create a heat flux at a junction of two different types of materials. A Peltier cooler, for example can be used, in which a solid-state active heat pump transfers heat from one side of the device to the other, with the consumption of electrical energy, depending on the direction of the current. Further, the substantially flat contour of the trailer top surface 1506 can provide a suitable installation platform for the concentrator apparatuses.

With reference to FIG. 16, an example system 1600 is shown including a concentrator apparatus 1620 installed with a shipping container 1602. The concentrator apparatus 1620 can be substantially analogous to the concentrator apparatus 920 and 1220 described herein. For example, the concentrator apparatus 1620 can utilize an arrangement of concentrating lenses to facilitate the omnidirectional concentration of light toward a light receiver. In this regard, a transfer medium can be introduced to the concentrator apparatus 1620 at a transfer medium inlet 1622. The transfer medium can receive thermal energy via the arrangement of concentrating lenses. The transfer medium can exit the concentrator apparatus 1620 having an increased temperature at the transfer medium outlet 1624. The concentrator apparatus 1620 is shown installed on a container top surface 1604.

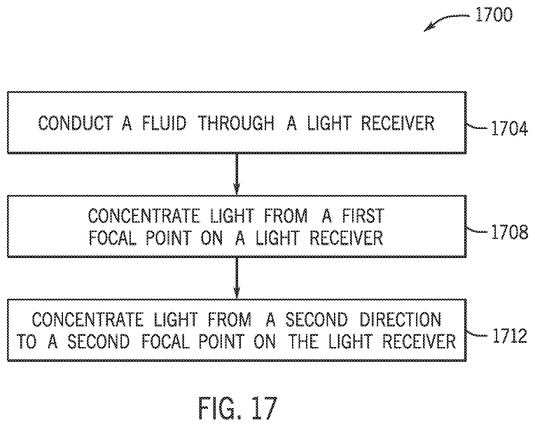

To facilitate the reader's understanding of the various functionalities of the embodiments discussed herein, reference is now made to the flow diagram in FIG. 17, which illustrates process 1700. While specific steps (and orders of steps) of the methods presented herein have been illustrated and will be discussed, other methods (including more, fewer, or different steps than those illustrated) consistent with the teachings presented herein are also envisioned and encompassed with the present disclosure.

At operation 1704, a fluid is conducted through a light receiver. For example and with reference to FIG. 12, a transfer medium 1260 is conducted through an inner member 1240. The inner member 1240 can be a light receiver that received concentrated solar radiation. The transfer medium 1260 can include one or more of water, a glycol/water mixture, hydrocarbon oils, refrigerants/phase change fluids, silicones, molten salts, a molecular solar thermal energy storage, or a zeolite-based thermal storage. The transfer medium 1260 can be conducted through the inner member by a circulation pump.

At operation 1708, light from a first direction is concentrated toward a first focal point on a light receiver. For example and with reference to FIGS. 9 and 12, light from the first direction D₁ can be concentrated toward the first focal point 956a. The light or solar radiation can be propagated along the first direction D₁. The solar radiation can be received by the concentrator apparatus 920. The solar radiation is directed through a subset of concentrating lenses, including the first concentrating lens 950a. The first concentrating lens 950a can include one or more refractive and/or contour surfaces to direct the radiation toward the first focal point 956a. The first focal point 956a is on or adjacent the inner member 940 in order to facilitate heating of the transfer medium within the inner volume 946.

At operation 1712, light from a second direction is concentrated toward a second focal point on the light receiver. For example and with reference to FIGS. 9 and 12, light from the second direction D₂ can be concentrated toward the second focal point 956b. The light or solar radiation can be propagated along the first direction D₂. The solar radiation can be received by the concentrator apparatus 920. The solar radiation is directed through a subset of concentrating lenses, including the second concentrating lens 950b. The second concentrating lens 950b can include one or more refractive and/or contour surfaces to direct the radiation toward the second focal point 956b. The second focal point 956b is on or adjacent the inner member 940 in order to facilitate heating of the transfer medium within the inner volume 946.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A concentrator apparatus, comprising:
a light receiver; and
a light concentrator arranged for omnidirectional concentration of light toward a first focal point on the light receiver and a second focal point on the light receiver.

2. The concentrator apparatus of claim 1, wherein the light concentrator comprises:
a first concentrating lens to induce the first focal point, and
a second concentrating lens to induce the second focal point.

3. The concentrator apparatus of claim 2, wherein the first and second concentrating lenses are circumferentially spaced about the light receiver.

4. The concentrator apparatus of claim 2, wherein a first side of the first concentrating lens is closer to the first focal point than a second side of the first concentrating lens.

5. The concentrator apparatus of claim 4, wherein a first side of the second concentrating lens is closer to the second focal point than a second side of the second concentrating lens.

6. The concentrator apparatus of claim 1, wherein the light concentrator comprises a transparent material at least partially surrounding the light receiver.

7. The concentrator apparatus of claim 6, wherein the light receiver comprises a pipe defining a fluid pathway, the transparent material positioned along the fluid pathway.

8. The concentrator apparatus of claim 7, wherein the transparent material is associated with a plurality of refractive surfaces arranged about the pipe.

9. The concentrator apparatus of claim 8, wherein
the transparent material defines at least one concentrating plane, the at least one concentrating plane including a midpoint, and
the plurality of refractive surfaces cooperate to induce the first focal point and the second point such that a focal axis of one or both of the first focal point or the second focal point forms a non-right angle with the midpoint of the at least one concentrating plane.

10. A concentrator apparatus, comprising:
a pipe defining a fluid pathway; and
an energy collection system associated with the pipe and configured to concentrate thermal energy received from a plurality of azimuths and altitudes on the pipe and heat fluid of the fluid pathway.

11. The concentrator apparatus of claim 10, wherein the energy collection system comprises a transparent material including:
a light receiving surface of the transparent material;
a light exiting surface of the transparent material opposite the light receiving surface;
a plurality of refractive surfaces incorporated into at least one of the light receiving surface and the light exiting surface;
a first side joining the light receiving surface and the light exiting surface; and
a second side opposite to and aligned with the first side, the second side joining the light receiving surface and the light exiting surface.

12. The concentrator apparatus of claim 11, wherein
the plurality of refractive surfaces directs light passing through the transparent material to a collective focal point; and
the first side of the transparent material is closer to the collective focal point than the second side of the transparent material.

13. The concentrator apparatus of claim 11, wherein the transparent material is at least semi-transparent.

14. The concentrator apparatus of claim 11, wherein at least a subset of the plurality of refractive surfaces includes progressively differing refractive angles from the first side of the transparent material to the second side of the transparent material.

15. The concentrator apparatus of claim 10, wherein the energy collection system comprises:
a portion moveable relative to the pipe, and
an arrangement of concentrating lenses between the portion and the pipe that are adapted to concentrate the thermal energy received from the plurality of azimuths and altitudes on the pipe.

16. The concentrator apparatus of claim 15, further comprising a catch mechanism disposed about the portion opposite the pipe, the catch mechanism adapted to receive a mechanical input for moving the first portion relative to the second portion.

17. The concentrator apparatus of claim 15, wherein the first and second portions are substantially concentric with a longitudinal axis of the pipe.

18. A system comprising:
a wind turbine; and
the concentrator apparatus of claim 10;
wherein the concentrator apparatus is installed with the wind turbine.

19. A system comprising:
a refrigeration truck; and
the concentrator apparatus of claim 10;
wherein the concentrator apparatus is installed with the refrigeration truck.

20. A system comprising:
a shipping container; and
the concentrator apparatus of claim 10;
wherein the concentrator apparatus is installed with the shipping container.

21. A method for supplying energy to a transfer medium, the method comprising:
conducting a fluid through a light receiver; and
transferring thermal energy to the fluid by:
concentrating light from a first direction to a first focal point on a light receiver; and
as the light transitions from the first direction to a second direction, concentrating the light from the second direction to a second focal point on the light receiver.

22. The method of claim 21, wherein the fluid comprises a heat transfer medium.

23. The method of claim 21, wherein the conducting comprises establishing a pressure gradient of the fluid through the light receiver using a pump.

24. The method of claim 21, further comprising collecting wind energy from an environment associated with the light receiver.

25. The method of claim 24, wherein the collecting comprises inducing movement of a first portion of an energy collection system using the wind energy.
